(19) United States
(12) Patent Application Publication
(10) Pub. No.: US 2020/0401009 A1
(43) Pub. Date: Dec. 24, 2020

(54) ELECTROCHROMIC ELEMENT HAVING PROTECTION LAYER

(71) Applicant: TINTABLE KIBING CO., LTD., TAINAN CITY (TW)

(72) Inventor: YI-WEN CHUNG, TAINAN CITY (TW)

(21) Appl. No.: 16/444,215

(22) Filed: Jun. 18, 2019

(51) Int. Cl. G02F 1/153; G02F 1/1524

(52) U.S. Cl. CPC G02F 1/1533; G02F 2001/1536; G02F 1/1524

(57) ABSTRACT

An electrochromic element having a protection layer is disclosed which comprises a first base material, a first transparent conductive layer, a first electrochromic layer, a protection layer, an electrolytic layer, a second electrochromic layer, a second transparent conductive layer and a second base material arranged in order. The protection layer is made of tin oxide (SnOₓ) or nickel oxide (NiOₓ).

### BACKGROUND OF THE INVENTION

### 1. Field of the Invention

The present invention relates to an electrochromic element having a protection layer which comprises the protection layer disposed between an electrochromic layer and an electrolytic layer for improving resistance to acid, alkaline and environment and providing an excellent adhesive effect for the electrochromic layer and the electrolytic layer.

### 2. Description of Related Art

An electrochromic material has an optical character of changing color and transparency by applying a voltage in which the phenomenon is reversible after the voltage is removed. Nowadays, the electrochromic materials are applied in various fields such as automobile industry, military industry and construction industry. For instance, the electrochromic materials can be used in manufacturing rearview mirrors and skylights of cars, a military equipment having camouflage effect, and windows of buildings according to different purposes.

Materials including Prussian blue, vanadium pentoxide, tungsten oxide, nickel oxide, molybdenum oxide, titanium oxide and cobalt oxide are frequently used in the electrochromic technology. An electrochromic element usually has a sandwich-like layered structure and comprises two outer layers made of a glass material or a plastic material as basal layers, and plural layers including a transparent conductive layer, an electrochromic layer, an ion-storage layer and an electrolytic layer between the two outer layers.

For instance, an electrochromic device and its manufacturing method disclosed in the Taiwan Pat No. TW I605154(B), issued on 11 Nov. 2017, comprises a substrate, a first transparent conductive layer, a first electrochromic layer, an ion-conductive layer, a second electrochromic layer and a second transparent conductive layer. An electrochromic device having an electrochromic element is also disclosed in the Taiwan Pat No. TW I534518(B), issued on 21 May 2016, in which the electrochromic element comprises two corresponding substrates, two transparent conductive layers respectively disposed on each of the two substrates, an ion-conductive layer disposed between the two transparent conductive layers, an electrochromic layer disposed between the ion-conductive layer and one transparent conductive layer, and an ion-storage layer disposed between the ion-conductive layer and the other transparent conductive layer.

In the conventional electrochromic elements mentioned above, the electrochromic layer is usually disposed adjacent to the electrolytic layer, e.g. the ion-conductive layer. However, the electrolytic layer adheres to the second electrochromic layer firmer than the first electrochromic layer in the conventional electrochromic element due to the materials chosen for manufacturing the electrolytic layer and the electrochromic layers. In addition, if the first electrochromic layer is made of tungsten oxide which has a great electrochemical property, the first electrochromic layer is easily hydrolyzed since tungsten oxide does not resist to acid, alkaline and environment. Therefore, the conventional electrochromic element is not reliable in use and has short service life.

Accordingly, it is important to improve adhesion between the electrochromic layer and the electrolytic layer and enhance the resistance of the electrochromic element to acid, alkaline and environment.

### SUMMARY OF THE INVENTION

The present invention discloses an electrochromic element having a protection layer to enhance an adhesive effect for an electrochromic layer and an electrolytic layer so as to adhere the electrolytic layer to the first electrochromic layer firmly. The protection layer also improves resistance of the electrochromic element to acid, alkaline and environment. In addition, the protection layer has excellent properties in electrochemical and ion conductivity.

The electrochromic element having a protection layer of the present invention comprises a first base material, a first transparent conductive layer, a first electrochromic layer, a protection layer, an electrolytic layer, a second electrochromic layer, a second transparent conductive layer and a second base material arranged in order, and the protection layer is made of tin oxide (SnOₓ) or nickel oxide (NiOₓ).

### BRIEF DESCRIPTION OF THE DRAWINGS

FIG. 1 is a schematic diagram showing a structure of an electrochromic element having a protection layer of the present invention;

FIG. 2 is a schematic diagram showing a surface roughness of a first electrochromic layer made of tungsten trioxide of the present invention;

FIG. 3 is a schematic diagram showing a surface roughness of a protection layer made of nickel oxide of the present invention;

FIG. 4 is a microscopic photograph showing a surface structure of a protection layer made of tin oxide of the present invention;

FIG. 5 is a microscopic photograph showing a surface structure of a protection layer made of nickel oxide of the present invention.

### DETAILED DESCRIPTION OF THE PREFERRED EMBODIMENT

To provide a thorough understanding, the purpose and advantages of the present invention will be described in detail with reference to the accompanying drawings.

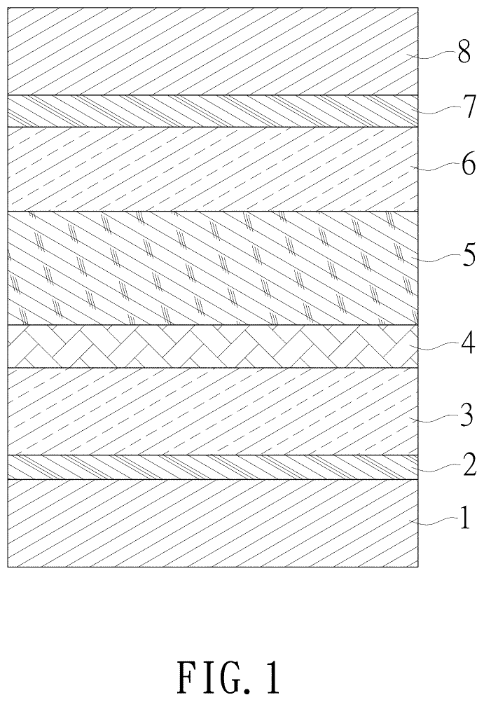

Referring to FIG. 1, the electrochromic element having a protection layer of the present invention comprises a first base material (1), a first transparent conductive layer (2), a first electrochromic layer (3), a protection layer (4), an electrolytic layer (5), a second electrochromic layer (6), a second transparent conductive layer (7) and a second base material (8) arranged in order. The protection layer (4) is manufactured by an E-beam evaporation method, a method of an E-beam evaporation combined with an ion-beam assisted deposition or a sputtering method. The protection layer (4) is made of tin oxide (SnOₓ) or nickel oxide (NiOₓ) in which the tin oxide (SnOₓ) has an O/Sn atomic ratio ranging from 1.5 to 2.5 and the nickel oxide (NiOₓ) has an O/Ni atomic ratio ranging from 0.5 to 1.5. In addition, the protection layer (4) has a surface roughness ranging from 5 nm to 40 nm and a thickness ranging from 25 nm to 150 nm.

The first electrochromic layer (3) is made of tungsten trioxide (WO₃) and the second electrochromic layer (6) is made of nickel (II) oxide (NiO). The first electrochronic layer (3) and the second electrochromic layer (6) are both manufactured by an E-beam evaporation method, a method of an E-beam evaporation combined with an ion-beam assisted deposition or a sputtering method.

In the following embodiments, practically applications of the present invention are provided, but the scope of the present invention is not limited by the following embodiments.

Referring to FIG. 1, the present invention has a first base material (1) and a second base material (8) disposed correspondingly to each other. Both the first base material (1) and the second base material (8) are made of a glass material or a plastic material. A first transparent conductive layer (2), a first electrochromic layer (3), a protection layer (4), an electrolytic layer (5), a second electrochromic layer (6) and a second transparent conductive layer (7) are formed in order on the first base material (1). At last, the second base material (8) is covered on the second transparent conductive layer (7) to form the electrochromic element having a protection layer of the present invention.

The first transparent conductive layer (2) is formed on the first base material (1) by a plating method, and the first base material (1) plated with the first transparent conductive layer (2) is then placed into an evaporator. The evaporator is vacuumed to a pressure needed, and an ion gun is turned on to remove static electricity and dust in a chamber of the evaporator. An oxygen gas with a flow rate ranging from 200 to 350 sccm is introduced into the evaporator as a process gas, and an electron beam gun is turned on for conducting an evaporation method of an E-beam evaporation and an ion-beam assisted deposition for assisting evaporation by an ion-beam source. Therefore, a first electrochromic layer (3) made of a tungsten trioxide (WO₃) thin film is formed on the first transparent conductive layer (2).

After the first electrochromic layer (3) is deposited on the first transparent conductive layer (2) to a specific thickness, the protection layer (4) is manufactured by the same method of E-beam evaporation combined with ion-beam assisted deposition on the first electrochromic layer (3). The protection layer (4) is made of tin oxide or nickel oxide and is formed under an oxygen gas with a flow rate of 200 to 400 sccm. A protection layer (4) made of a tin oxide (SnOₓ) thin film having a thickness ranging from 25 nm to 150 nm or a nickel oxide (NiOₓ) thin film having a thickness ranging from 25 nm to 150 nm is then formed on the first electrochromic layer (3). Therefore, the protection layer (4) is formed between the first electrochromic layer (3) and the electrolytic layer (5) to provide an excellent adhesive effect between the first electrochromic layer (3) and the electrolytic layer (5) and improve reliability of the electrochromic element having a protection layer of the present invention.

The protection layer (4) is analyzed by an energy-dispersive X-ray spectroscopy (EDX) and the analyzing result indicates that the tin oxide (SnOₓ) of the protection layer (4) has an O/S atomic ratio ranging from 1.5 to 2.5, and the nickel oxide (NiOₓ) has an O/Ni atomic ratio ranging from 0.5 to 1.5.

In addition, each of the first electrochromic layer (3) and the protection layer (4) has a rough surface to enhance adhesion between the first electrochromic layer (3) and the protection layer (4). Surface roughness of the first electrochromic layer (3) and the protection layer (4) are analyzed by a profilometer (model: α-step).

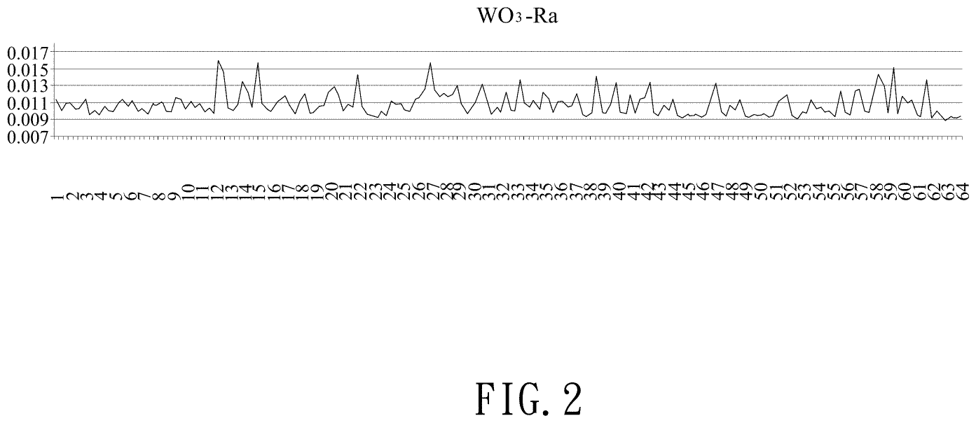

FIG. 2 is a schematic diagram showing a surface roughness of the first electrochromic (3). In this embodiment, 64 samples are analyzed and the analyzing result indicates that the first electrochromic layer (3) made of tungsten oxide (WO₃) has an average surface roughness of 0.0108 μm.

The protection layer (4) is a tin oxide (SnOₓ) thin film or a nickel oxide (NiOₓ) thin film. Table 1 shown the analyzing results of the surface roughness of the protection layer (4) made of tin oxide (SnOₓ) under different oxygen gas flow rate.

TABLE 1

| | | | | | |
|---|---|---|---|---|---|
| Oxygen gas | 50 | 100 | 150 | 200 | 250 |
| flow rate | | | | | |
| (sccm) | | | | | |
| Surface | 0.0236 | 0.0281 | 0.0243 | 0.0301 | 0.0291 |
| roughness | | | | | |
| (μm) | | | | | |

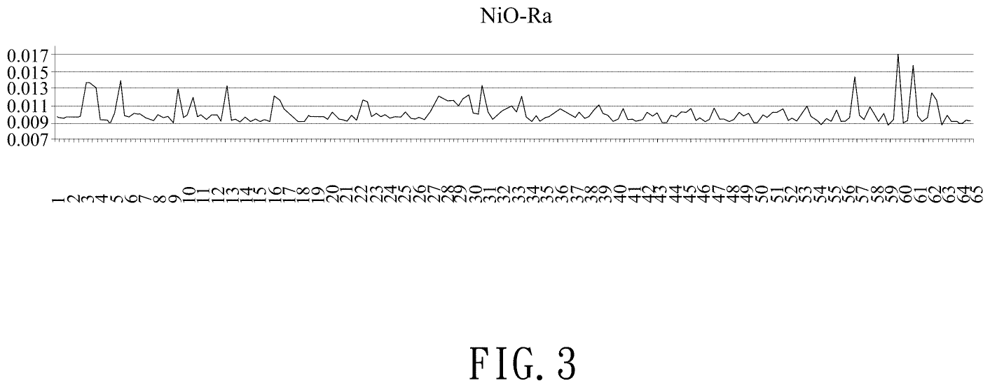

According to table 1, oxygen gas flow rate introduced into the evaporator when conducting the method of E-beam evaporation combined with ion-beam assisted deposition affects surface roughness of the film formed. The protection layer (4) made of tin oxide (SnOₓ) has an average surface roughness of 0.027 μm. FIG. 3 shows a schematic diagram of a surface roughness of a protection layer (4) made of nickel oxide (NiOₓ) under an oxygen gas flow rate of 350 sccm, and the protection layer (4) made of NiOₓ has an average surface roughness of 0.0102 μm.

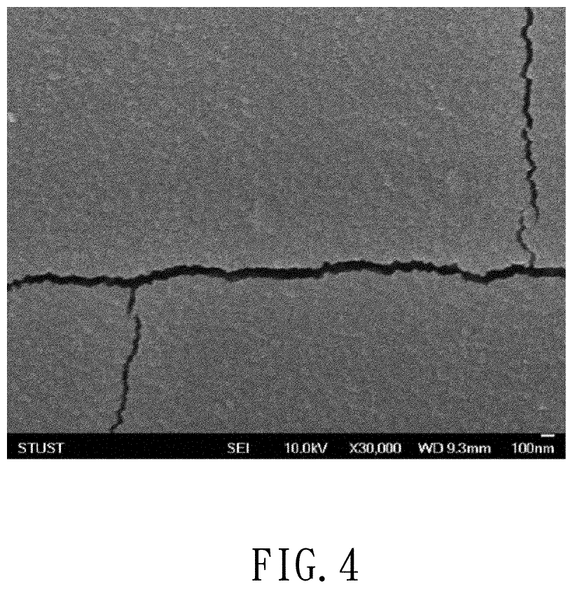

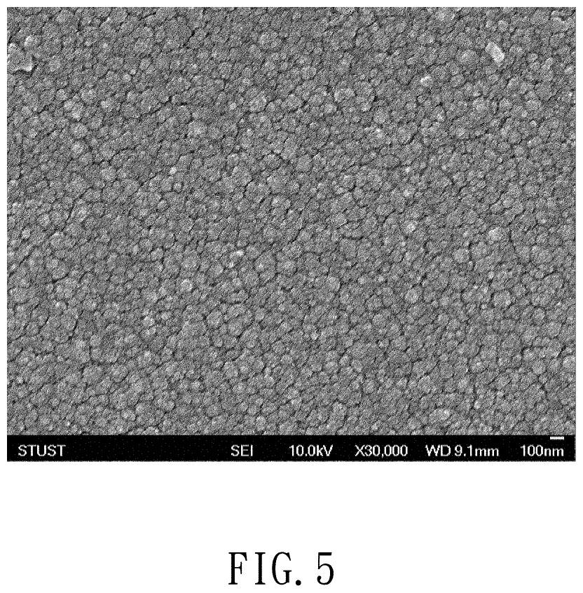

FIG. 4 and FIG. 5 are photographs taken by scanning electron microscope showing surface structures of the protection layer (4) formed on the first electrochromic layer (3). FIG. 4 shows a surface structure of a protection layer (4) made of tin oxide (SnOₓ), and FIG. 5 shows a surface structure of a protection layer (4) made of nickel oxide (NiOₓ). According to FIG. 4 and FIG. 5, the protection layer (4) made of tin oxide (SnOₓ) or nickel oxide (NiOₓ) has a rough surface.

According to the embodiments described above, the present invention has following advantages compared to the previous technique:

1. In a structure of a conventional electrochromic element, an electrolytic layer adheres to a second electrochromic layer firmer than to a first electrochromic layer. However, the electrochromic element having a protection layer of the present invention comprises a protection layer between a first electrochromic layer and an electrolytic layer which improves adhesion between the first electrochromic layer and the electrolytic layer and increases reliability of the present invention.

2. The protection layer of the present invention is formed on the first electrochromic layer and made of tin oxide (SnOₓ) or nickel oxide (NiOₓ) which enhances resistance of the first electrochronic layer made of tungsten oxide (WO₃) to acid, alkaline and environment. Therefore, the protection layer of the present invention prevents the first electrochromic layer from corrosion or hydrolyzation and increases service life of the electrochromic element.

What is claimed is:

1. An electrochromic element having a protection layer, comprising a first base material, a first transparent conductive layer, a first electrochromic layer, a protection layer, an electrolytic layer, a second electrochromic layer, a second transparent conductive layer and a second base material arranged in order, wherein the protection layer is made of tin oxide (SnOₓ) or nickel oxide (NiOₓ).

2. The electrochromic element having a protection layer as claimed in claim 1, wherein the first electrochromic layer is made of tungsten trioxide (WO₃) and manufactured by an E-beam evaporation method, a method of an E-beam evaporation combined with an ion-beam assisted deposition, or a sputtering method.

3. The electrochromic element having a protection layer as claimed in claim 1, wherein the second electrochromic layer is made of nickel(II) oxide (NiO) and manufactured by an E-beam evaporation method, a method of an E-beam evaporation combined with an ion-beam assisted deposition, or a sputtering method.

4. The electrochromic element having a protection layer as claimed in claim 1, wherein the tin oxide (SnOₓ) has an O/Sn atomic ratio ranging from 1.5 to 2.5, and the nickel oxide (NiOₓ) has an O/Ni atomic ratio ranging from 0.5 to 1.5.

5. The electrochromic element having a protection layer as claimed in claim 1, wherein the protection layer has a surface roughness ranging from 5 nm to 40 nm.

6. The electrochromic element having a protection layer as claimed in claim 1, wherein the protection layer has a thickness ranging from 25 nm to 150 nm.

7. The electrochromic element having a protection layer as claimed in claim 1, wherein the protection layer is manufactured by an E-beam evaporation method, a method of an E-beam evaporation combined with an ion-beam assisted deposition or a sputtering method.
